(19) United States
(12) Patent Application Publication
(10) Pub. No.: US 2026/0153869 A1
(43) Pub. Date: Jun. 4, 2026

(54) ROUTE CORRECTION METHOD AND AUTONOMOUS MOBILE DEVICE

(71) Applicant: Wistron Corporation, New Taipei City (TW)

(72) Inventors: Shih Hong Yang, New Taipei City (TW); Chun Wei Wu, New Taipei City (TW); Chen Wei Yang, New Taipei City (TW); Shao Huan Chen, New Taipei City (TW); Chun Wei Wang, New Taipei City (TW)

(73) Assignee: Wistron Corporation, New Taipei City (TW)

(21) Appl. No.: 19/017,758

(22) Filed: Jan. 12, 2025

(30) Foreign Application Priority Data
Nov. 29, 2024 (TW) 113146236

(51) Int. Cl. G05D 1/60; G05D 1/24; G05D 111/10; G06T 3/40; G06T 9/00

(52) U.S. Cl. CPC G05D 1/60; G05D 1/24; G06T 3/40; G06T 9/008; G05D 2111/10

(57) ABSTRACT

A route correction method and an autonomous mobile device are provided. A reference position information corresponding to a reference point in a captured image is determined. The captured image is taken from the reference point in an environment. A deviation information between an estimated position information and the reference position information is determined. The estimated position information is estimated based on a motion information of the autonomous mobile device. A moving route information of the autonomous mobile device is corrected based on the deviation information. The moving route information corresponds to a route between the estimated position information and a positioning-point position information. As a result, accuracy and reliability of positioning may be improved.

### CROSS-REFERENCE TO RELATED APPLICATION

This application claims the priority benefit of Taiwan application serial no. 113146236, filed on Nov. 29, 2024. The entirety of the above-mentioned patent application is hereby incorporated by reference herein and made a part of this specification.

### BACKGROUND

### Technical Field

The disclosure relates to a route planning technology, and in particular to a route correction method and an autonomous mobile device.

### Description of Related Art

Current unmanned aerial vehicles (UAVs) may encounter the following issues:

Human operation: When a UAV cannot accurately position itself, human operation is required to correct the position of the UAV. This results in reduced mission execution efficiency and increased costs.

Sensor installation: UAV sensors may be used for environmental perception. However, in complex environments, the data processing of the sensors remains challenging.

Path planning: Most current UAV systems use advanced path algorithms, but these are not suitable for enclosed areas lacking satellite positioning.

### SUMMARY

The disclosure provides a route correction method and an autonomous mobile device, which may achieve accurate positioning in enclosed areas.

A route correction method in the embodiments of the disclosure is applicable to an autonomous mobile device. The route correction method includes, but is not limited to, the following steps. A reference position information corresponding to a reference point in a captured image is determined, and the captured image is taken from the reference point in an environment. A deviation information between an estimated position information and the reference position information is determined, and the estimated position information is estimated based on a motion information of the autonomous mobile device. A moving route information of the autonomous mobile device is corrected according to the deviation information, and the moving route information corresponds to a route between the estimated position information and a positioning-point position information.

An autonomous mobile device in the embodiments of the disclosure includes, but is not limited to, a storage and a processor. The storage stores a code. The processor is coupled to the storage. The processor loads the code and executes the following steps. A reference position information corresponding to a reference point in a captured image is determined, and the captured image is taken from the reference point in an environment. A deviation information between an estimated position information and the reference position information is determined, and the estimated position information is estimated based on a motion information of the autonomous mobile device. A moving route information of the autonomous mobile device is corrected according to the deviation information, and the moving route information corresponds to a route between the estimated position information and a positioning-point position information.

Based on the above, the route correction method and the autonomous mobile device in the embodiments of the disclosure use the deviation information between the reference position information determined based on an image and the estimated position information determined based on motion information to correct the moving route information. As a result, the accuracy of positioning may be improved, thereby enhancing the efficiency of cruise missions.

To make the features and advantages of the disclosure more comprehensible, several embodiments accompanied with drawings are described in detail as follows.

### BRIEF DESCRIPTION OF THE DRAWINGS

FIG. 1 is a component block diagram of an autonomous mobile device according to an embodiment of the disclosure.

FIG. 2 is a flowchart of a route correction method according to an embodiment of the disclosure.

FIG. 3 is a schematic diagram of deviation information according to an embodiment of the disclosure.

FIG. 4 is a schematic diagram of moving route information according to an embodiment of the disclosure.

FIG. 5 is a schematic diagram of moving route information according to an embodiment of the disclosure.

FIGS. 6A to 6C are schematic diagrams of scaling factors according to an embodiment of the disclosure.

FIG. 7 is a schematic diagram of moving route information according to an embodiment of the disclosure.

FIG. 8 is a schematic diagram of moving route information according to an embodiment of the disclosure.

### DESCRIPTION OF THE EMBODIMENTS

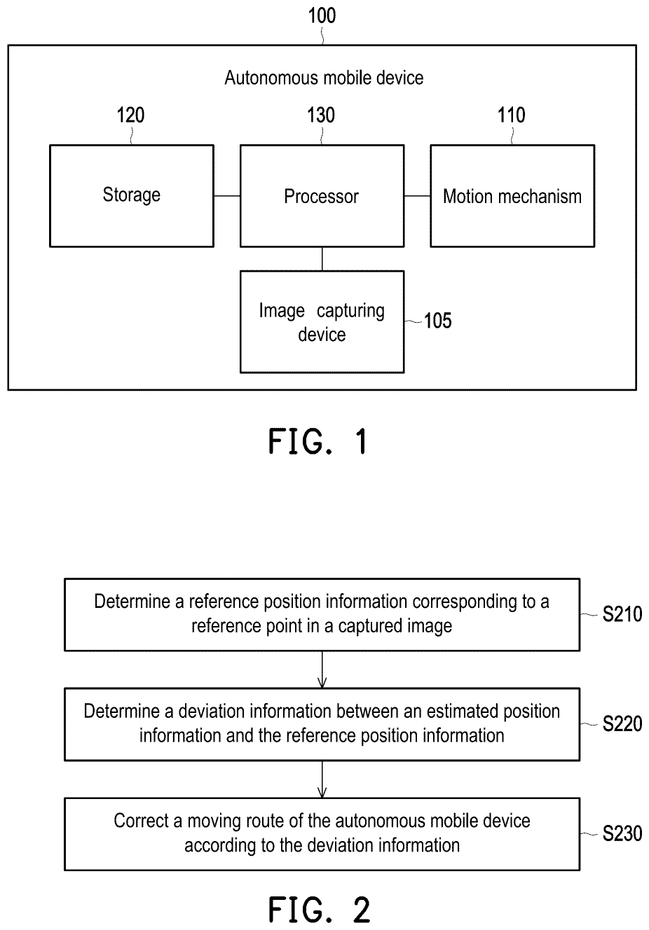

FIG. 1 is a component block diagram of an autonomous mobile device 100 according to an embodiment of the disclosure. Referring to FIG. 1, the autonomous mobile device 100 includes, but is not limited to, an image capturing device 105, a motion mechanism 110, a storage 120, and a processor 130. The autonomous mobile device 100 may be an unmanned aerial vehicle (UAV), an unmanned aircraft, an autonomous aircraft, an autonomous mobile robot (AMR), an automated guided vehicle (AGV), an unmanned or computer-driven vehicle, a robotic vacuum, or another movable device.

The image capturing device 105 may be a camera, a video camera, or another device, module, or element equipped with image capturing capabilities. The image capturing device 105 may include image sensors (e.g., a charge-coupled device (CCD), a complementary metal-oxide-semiconductor (CMOS)), optical lenses, image control circuits, and similar elements. In the embodiment of the disclosure, the image capturing device 105 is used to capture images of the external environment. For example, the image capturing device 105 captures images of the environment in which the autonomous mobile device 100 is located to obtain captured images. The captured images are the images captured by the image capturing device 105 from the environment. The environment may include, for example, a farm, a factory, or the ocean, without being limited thereto.

The motion mechanism 110 may include a power unit (e.g., a motor or engine), a transmission system (e.g., a drive shaft or gear shaft), and a driving unit (e.g., wheels, tracks, or propellers). In some embodiments, the function of the motion mechanism 110 is achieved by controlling the power unit (e.g., the motor or engine) to drive the driving unit to perform actions for changing position, moving, flying, or navigating.

The storage 120 may be any type of fixed or removable random access memory (RAM), read-only memory (ROM), flash memory, traditional hard disk drive (HDD), solid-state drive (SSD), or similar elements. In an embodiment, the storage 120 is used to store codes, software modules, configuration settings, data, or files (e.g., position information, deviation information, or moving route information), which will be described in detail in subsequent embodiments.

The processor 130 is coupled to the image capturing device 105, the motion mechanism 110, and the storage 120. The processor 130 may be a central processing unit (CPU), a graphics processing unit (GPU), or another programmable general-purpose or special-purpose microprocessor, digital signal processor (DSP), programmable controller, field-programmable gate array (FPGA), application-specific integrated circuit (ASIC), neural network accelerator, or a combination of such elements or similar elements. In an embodiment, the processor 130 is used to perform all or part of the operations of the autonomous mobile device 100 and may load and execute the codes, software modules, files, and data stored in the storage 120.

In the following text, the methods described in the embodiments of the disclosure will be explained in conjunction with the various mechanisms, devices, elements, and modules in the autonomous mobile device 100. Each process of the method may be adjusted according to the implementation scenario and is not limited thereto.

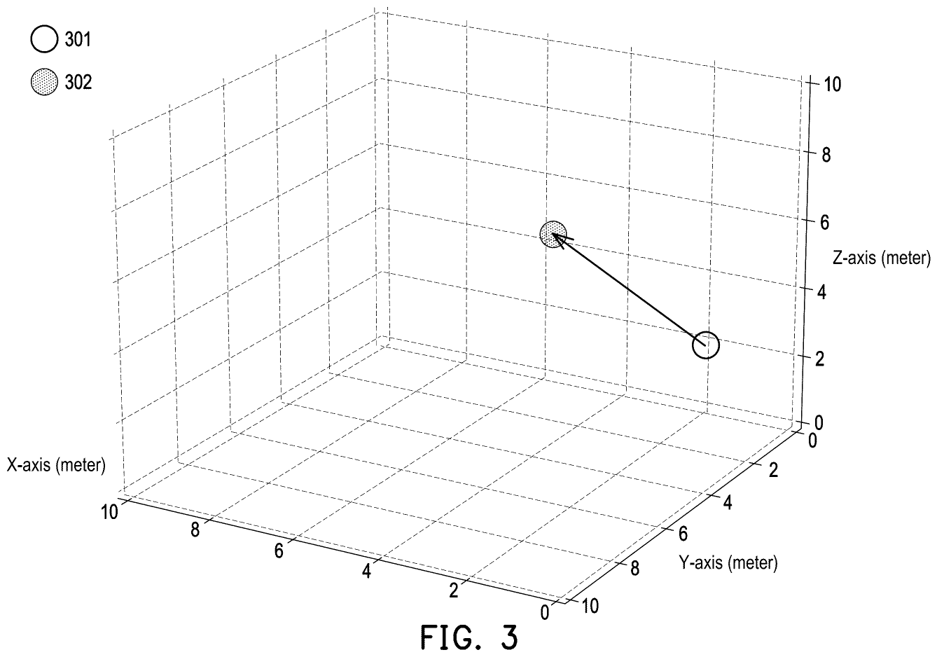

FIG. 2 is a flowchart of a route correction method according to an embodiment of the disclosure. Referring to FIG. 2, the processor 130 determines a reference position information corresponding to a reference point in a captured image (step S210). Specifically, the captured image is obtained by the image capturing device 105 taking images of a reference point in an environment. The reference position information corresponding to the reference point is pre-configured or pre-determined. The reference position information may be coordinates in any coordinate system (e.g., latitude, longitude, and altitude or other custom two-dimensional/three-dimensional coordinate systems) or a relative position to a reference object (e.g., relative distance and/or direction) and is used to indicate the position of the reference point.

In an embodiment, the processor 130 may convert the captured image into a vector encoding. The vector encoding is one-dimensional. That is, the processor 130 converts the two-dimensional captured image into a one-dimensional vector encoding.

For example, the processor 130 performs a convolution operation on the captured image. The captured image serves as the input image for the convolution operation and may be regarded as a three-dimensional tensor with dimensions H×W×C. H represents the total number of pixels corresponding to the height of the captured image, W represents the total number of pixels corresponding to the width of the captured image, and C represents the number of channels (for a red-green-blue (RGB) image, C equals 3). The mathematical expression for the convolution operation is: Y=X*W+b, where X is the input image (e.g., the captured image from the image capturing device 105), W is the convolution kernel (or weight), * denotes the convolution operation, b is the bias term, and Y is the output feature map. The dimensions of the output feature map may be H′×W′×D, where H′ represents the total number of pixels corresponding to the height of the output feature map, W′ represents the total number of pixels corresponding to the width of the output feature map, and D is the number of channels of the output feature map.

The processor 130 flattens the three-dimensional output feature map Y into a one-dimensional vector, mathematically expressed as: z=Flatte(Y), where z is the one-dimensional vector with a size of 1×(H′×W′×D). Next, the processor 130 performs a linear projection on the flattened one-dimensional vector to obtain the final embedding vector or feature representation (i.e., vector encoding). The mathematical expression is: z′=W_{f}·z+b_{f}, where W_{f} is the projection matrix with dimensions n×(H′×W′×D) (n is a positive integer), and b_{f} is the bias term. Finally, the output vector encoding z′ is a one-dimensional vector with a size of n, which represents the embedding vector in the feature space.

In some embodiments, a trained Vision Integrates Transformer (ViT) Mamba module may be used to implement the function of converting the three-dimensional image into a one-dimensional vector. Specifically, the processor 130 inputs the captured image into the trained Vision Integrates Transformer Mamba module to generate the corresponding vector encoding. The Vision Integrates Transformer Mamba module is characterized by its lightweight design compared to other machine learning models.

The processor 130 determines the reference position information corresponding to the vector encoding. The processor 130 may pre-store a correspondence between one or more reference vector encodings and their corresponding reference position information and use this correspondence to find the reference position information corresponding to the reference point in the captured image. For example, the processor 130 searches for a reference vector encoding that matches the vector encoding of the captured image and retrieves the reference position information associated with this reference vector encoding from the correspondence.

In another embodiment, the vector encoding may be in the form of text, symbols, or numbers, and the processor 130 may directly derive the reference position information from the vector encoding in text, symbol, or number form. For example, the vector encoding may be binary representations of latitude and longitude coordinates or three-dimensional coordinates.

Referring to FIG. 2, the processor 130 determines the deviation information between the estimated position information and the reference position information (step S220). Specifically, the estimated position information is estimated based on the motion information of the autonomous mobile device 100. The estimated position information may be coordinates in any coordinate system (e.g., latitude, longitude, and altitude or other custom two-dimensional/three-dimensional coordinate systems) or a relative position to a reference object (e.g., relative distance and/or direction) and is used to indicate the estimated position. The motion information may include, for example, travel distance/speed and direction of movement.

In an embodiment, the processor 130 determines the estimated position information corresponding to the motion information of the autonomous mobile device 100 based on initial position information, which is known. For example, if the initial position information is the coordinate (0,0,0), and the motion information indicates a forward movement of 300 meters per minute, then the estimated position information after one minute would be the coordinate (300,0,0). In an application scenario where the autonomous mobile device 100 is a UAV, the processor 130 may determine the current estimated position information using a dead reckoning algorithm.

In an embodiment, the estimated position information includes a first estimated coordinate at the current time point. For example, this may be a coordinate composed of latitude, longitude, and altitude determined using a dead reckoning algorithm. The reference position information includes a first reference coordinate at the current time point. For example, this may be a coordinate composed of latitude, longitude, and altitude converted from the captured image. The deviation information includes a deviation value between the first estimated coordinate and the first reference coordinate. The deviation value may include the difference between the longitude of the estimated position information and the longitude of the reference position information, the difference between the latitude of the estimated position information and the latitude of the reference position information, and the difference between the altitude of the estimated position information and the altitude of the reference position information. However, the aforementioned coordinates are not limited to latitude, longitude, and altitude as the measurement units. For example, custom two-dimensional or three-dimensional coordinate system coordinates may also be used.

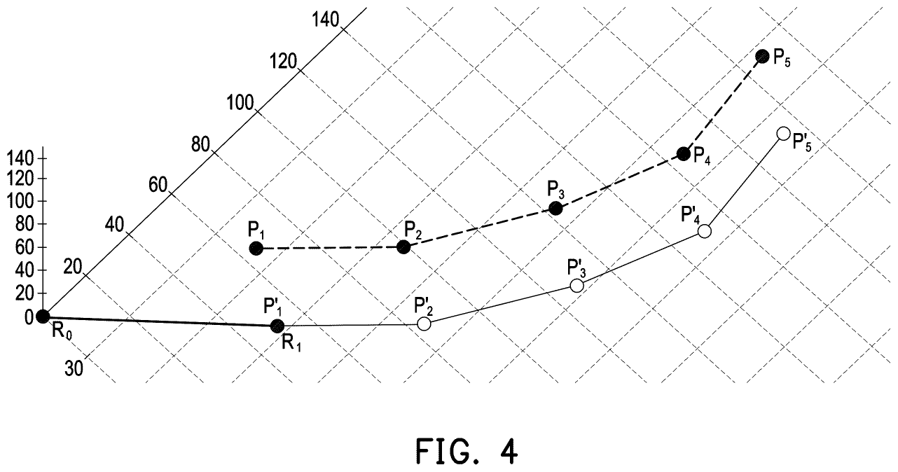

For example, FIG. 3 is a schematic diagram of deviation information according to an embodiment of the disclosure. Referring to FIG. 3, the estimated position information is the estimated coordinate (X1, Y1, Z1) of the estimated point 301, and the reference position information is the reference coordinate (X2, Y2, Z2) of the reference point 302. The deviation value is the difference between the estimated coordinate of the estimated point 301 and the reference coordinate of the reference point 302 along the three axes (e.g., the X-axis, Y-axis, and Z-axis). For example, [X2-X1, Y2-Y1, Z2-Z1]. The arrow/vector shown in the figure from the estimated point 301 to the reference point 302 represents this deviation value.

Referring to FIG. 2, the processor 130 corrects the moving route information of the autonomous mobile device 100 based on the deviation information (step S230). Specifically, the original moving route information corresponds to a route between the estimated position information and the positioning-point position information. The positioning-point position information corresponds to one or more positioning points in the total route of the autonomous mobile device 100. The positioning-point position information includes the position information of one or more positioning points. The positioning-point position information may be coordinates in any coordinate system (e.g., latitude, longitude, and altitude or other custom two-dimensional/three-dimensional coordinate systems) or a relative position to a reference object (e.g., relative distance and/or direction) and is used to indicate the position of the positioning points. The processor 130 is pre-configured to move between multiple positioning points. The processor 130 pre-determines the sequence of these positioning points and determines the route and corresponding reference route information between two positioning points based on this sequence. The reference route information may include, for example, one or more combinations of distances and corresponding directions for moving from a first positioning point to a second positioning point. The total route of the autonomous mobile device 100 is the set of routes passing through these positioning points.

Before correction, the processor 130 assumes that the estimated point corresponding to the estimated position information should lie on the route corresponding to the reference route information between two positioning points. Therefore, the original moving route information corresponds to a route between the estimated point corresponding to the estimated position information and the next positioning point corresponding to the positioning-point position information. For example, it may include one or more combinations of distances and corresponding directions for moving from the estimated point at the current time to the next positioning point.

In an embodiment, the processor 130 may correct a positioning point corresponding to the positioning-point position information into a new positioning point based on the deviation value. For example, the processor 130 adds the deviation value to the coordinates of the positioning point. The new positioning point and the original positioning point then have the deviation value between them.

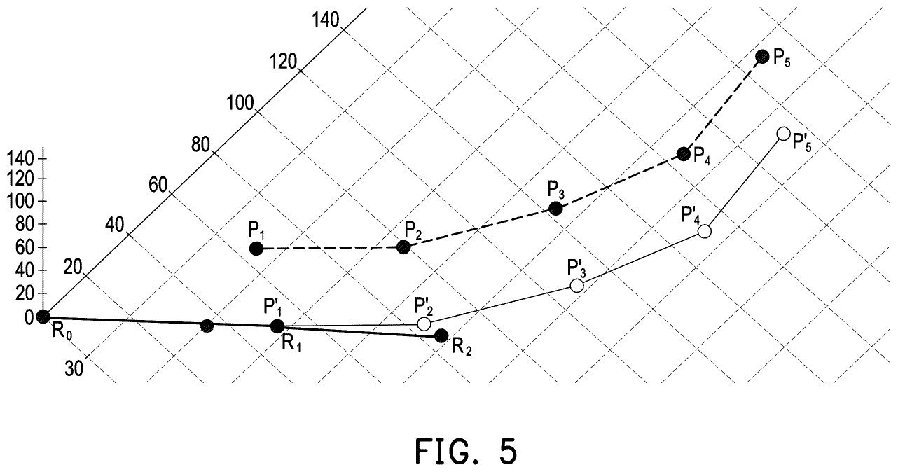

For example, FIG. 4 is a schematic diagram of moving route information according to an embodiment of the disclosure. Referring to FIG. 4, actual points R₀ and R₁ (with coordinates (x_{R0}, y_{R0}, z_{R0}) and (x_{R1}, y_{R1}, z_{R1}), respectively) are positions of the autonomous mobile device 100 at two time points as determined based on the reference position information (e.g., reference coordinates). Thus, the matrix of the actual route R is R=[x_{R0} y_{R0} z_{R0}], [x_{R1} y_{R1} z_{R1}]. For example, R=[70 37 47], [120 60 90]. Positioning points P₁, P₂, P₃, P₄, and P₅ (with coordinates (x_{P1}, y_{P1}, z_{P1}), (x_{P2}, yₚ₂, zₚ₂), (xₚ₃, y_{P3}, zₚ₃), (xₚ₄, yₚ₄, zₚ₄), and (xₚ₅, yₚ₅, z_{P5}), respectively) correspond to the positioning-point position information of the autonomous mobile device 100 as determined based on the estimated position information. The matrix of the total route P corresponding to the positioning-point position information is P=[x_{P1} y_{P1} z_{P1}], [x_{P2} y_{P2} z_{P2}], [x_{P3} yₚ₃ z_{P3}], [x_{P4} y_{P4} z_{P4}], [x_{P5} y_{P5} z_{P5}]. For example, P=[50 48 60], [95 70 100], [128 107 125], [144 150 123], [132 199 100].

Assuming that the processor 130 determines that the current time point is at the positioning point P₁, as a result, the processor 130 uses the coordinates (x_{P1}, y_{P1}, z_{P1}) of the positioning point P₁ as the first estimated coordinate. The coordinates (x_{R1}, y_{R1}, z_{R1}) of the actual point R₁ at the current time point are used as the first reference coordinate. Thus, the deviation value is Δ=R₁−P₁=[Δₓ Δ_{y} Δ_{z}]. For example, Δ=[20-11-13]. The new positioning points P′₁, P′₂, P′₃, P′₄, P′₅ (with coordinates (x_{P′1}, y_{P′1}, z_{P′1}), (x_{P′2}, y_{P′2}, z_{P′2}), (x_{P′3}, y_{P′3}, z_{P′3}), (x_{P′4}, y_{P′4}, z_{P′4}), and (x_{P′5}, y_{P′5}, z_{P′5}), respectively) correspond to the positions corrected based on the deviation information. The matrix of a total route P′ corresponding to the corrected moving route information is P′=P+Δ=[x_{P1}+Δₓ y_{P1}+Δ_{y} z_{P1}+Δ_{z}], [x_{P2}+Δₓ y_{P2}+λ_{y} z_{P2}+Δ_{z}], [x_{P3}+Δₓ y_{P3}+Δ_{y} z_{P3}+Δ_{z}], [x_{P4}+Δₓ y_{P4}+Δ_{y} z_{P4}+Δ_{z}], [x_{P5}+Δₓ y_{P5}+Δ_{y} z_{P5}+Δ_{z}]. For example, P′=[70 37 47], [115 59 87], [148 96 112], [164 139 110], [152 188 87]. At this time, the new positioning point P′₁ overlaps with the reference point R₁. That is, the coordinates of the new positioning point P′₁ are the same as those of the reference point R₁.

In an embodiment, the processor 130 may determine whether the deviation information meets a correction condition. The correction condition is that the deviation value corresponding to the deviation information is greater than a deviation threshold value. For example, the deviation value along any of the three axes is greater than 10 meters (i.e., the deviation threshold value). In response to the deviation information meeting the correction condition, the processor 130 may correct the moving route information of the autonomous mobile device 100. For instance, if the deviation value corresponding to the deviation information is greater than the deviation threshold value, the processor 130 adjusts the positioning point into a new positioning point. In response to the deviation information not meeting the correction condition, the processor 130 may prohibit or refrain from correcting the moving route information of the autonomous mobile device 100. For example, if the deviation value corresponding to the deviation information is not greater than the deviation threshold value, the positioning point remains unchanged.

In an embodiment, the corrected moving route information includes multiple new positioning coordinates of multiple new positioning points. For example, these may include the coordinates of the new positioning points P′₁, P′₂, P′₃, P′₄, P′₅ from the embodiment in FIG. 4.

The reference position information includes multiple reference coordinates of multiple reference points corresponding to these new positioning points. For instance, this may include the coordinates of the actual points R₀ and R₁ in the embodiment of FIG. 4.

The processor 130 may determine a loss function based on the distance between two of the new positioning points and the distance between two of the reference points. The distance between two of the new positioning points corresponds to the difference between their respective new positioning coordinates. For example, in the embodiment of FIG. 4, the difference between the two new positioning coordinates (x_{P′1}, y_{P′1}, z_{P′1}) and (x_{P′2}, y_{P′2}, z_{P′2}) of the new positioning points P′₁ and P′₂ is (x_{P′2}−x_{P′1}, y_{P′2}−y_{P′1}, z_{P′2}−z_{P′1}). The distance between two of the reference points corresponds to the difference between their respective reference coordinates. For example, in the embodiment of FIG. 4, the difference between the two reference coordinates (x_{R0}, y_{R0}, z_{R0}) and (x_{R1}, y_{R1}, z_{R1}) of the actual points R₀ and R₁ is (x_{R1}−x_{R0}, y_{R1}−y_{R0}, z_{R1}−z_{R0}).

In some application scenarios, the total route P′ corresponding to the corrected moving route information may not correctly align the route. In this case, it is necessary to consider the scaling ratio (referred to as the scaling factor below) between the distance of two new positioning points and the distance of two actual points. In the loss function, the difference between the two new positioning coordinates corresponds to the scaling factor. In other words, the loss function is based on the error between the distance of two actual points and the scaled distance of two new positioning points.

In an embodiment, the loss function is the difference between a first value and a second value. The first value is the distance between two of the new positioning points, and the second value is the product of the distance between two of the reference points and the scaling factor. For example, a scaling factor S is represented as a matrix S=[Sₓ S_{y} S_{z}]. A vector d corresponding to the distance between two points A and B (with coordinates (Aₓ, A_{y}, A_{z}) and (Bₓ, B_{y}, B_{z}), respectively) is d_{A-B}=[Aₓ−Bₓ A_{y}−B_{y} A_{z}−B_{z}]. The loss function is expressed as

$$Loss ( S ) = {\sum }_{i = 1}^{n} {‖ {d}_{{R}_{( i + 1 )} - {R}_{i}} - {d}_{{P}_{( i + 1 )}^{′} - {P}_{i}^{′}} \cdot S ‖}^{2} .$$

Here, the vector d_{R}_{₍ᵢ₊₁₎}−_{R}_{ᵢ} corresponds to the distance between the i+1th actual point R₍ᵢ₊₁₎ and the ith actual point Rᵢ (i.e., the difference between the two reference coordinates), d_{p′}_{₍ᵢ₊₁₎}_{-p′}_{ᵢ} corresponds to the distance between the i+1th new positioning point P′₍ᵢ₊₁₎ and the ith new positioning point P′ᵢ (i.e., the difference between the two new positioning coordinates), and n is a positive integer.

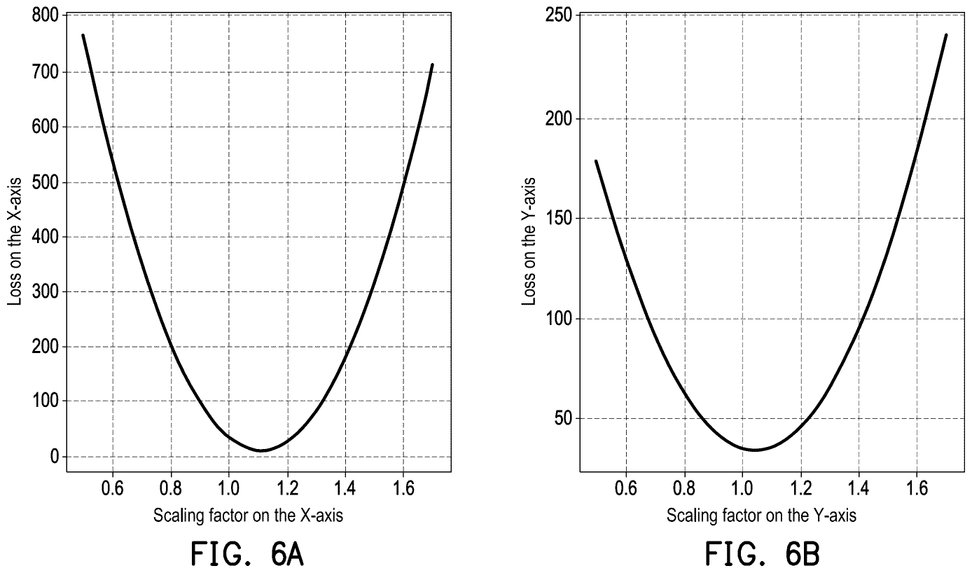

For example, FIG. 5 is a schematic diagram of moving route information according to an embodiment of the disclosure. Referring to FIG. 5, the new positioning coordinate of the new positioning point P′₁ is (70, 37, 47), and the new positioning coordinate of the new positioning point P′₂ is (95, 70, 100). Additionally, the new positioning coordinate of the actual point R₁ is (70, 37, 47), and the new positioning coordinate of the actual point R₂ is (120, 60, 90). These coordinates may be substituted into the loss function to calculate Loss(S).

Next, the processor 130 minimizes the loss function and determines the scaling factor. In other words, the error between the distance of two actual points and the scaled distance of two new positioning points is minimized, and the scaling factor that results in the minimum error for the loss function is calculated. At this point, the scaling factor is used to correct the two new positioning coordinates.

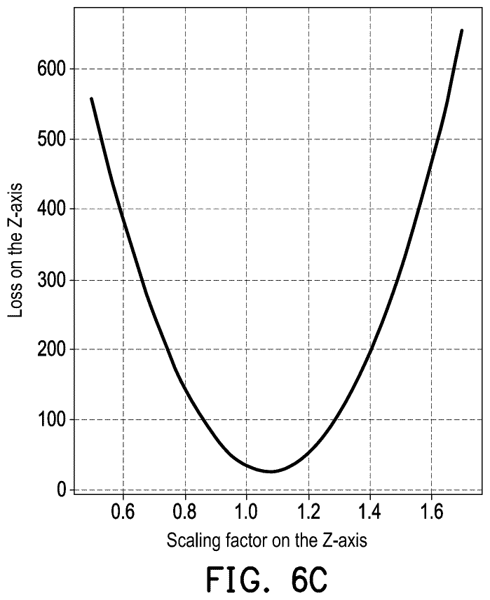

For example, FIGS. 6A to 6C are schematic diagrams of scaling factors according to an embodiment of the disclosure. Referring to FIGS. 6A to 6C, they respectively show the relationship between the loss function's loss (e.g., the range of values of the loss function Loss(S)) and the values of the scaling factor along the X-axis, Y-axis, and Z-axis. In these figures, the matrix of the scaling factor S is S=[1.111 1.045 1.075]. That is, when the scaling factor S has values of 1.111, 1.045, and 1.075 on the X-axis, Y-axis, and Z-axis, respectively, the loss function has the minimum loss/error on the X-axis, Y-axis, and Z-axis.

In an embodiment, the processor 130 determines the minimum value of the loss function using a gradient descent method. The minimum value (i.e., the aforementioned minimum loss/error) corresponds to the scaling factor. Gradient descent is a method that iteratively updates parameters (e.g., the scaling factor) to find a solution (i.e., the value of the loss function). Therefore, the processor 130 may initially generate a random solution for the parameters and calculate the gradient direction and magnitude of this solution. Then, by continuously updating the parameters, the gradient direction and magnitude are adjusted, causing the loss function to gradually approach the minimum value. For instance, the minimum loss in FIGS. 6A to 6C is the valley/lowest point of the loss function, and the gradient descent algorithm seeks the valley/lowest point starting from a certain point on the loss function.

In other embodiments, the processor 130 may also use a momentum gradient descent method, an adaptive moment estimation (Adam) method, Newton's method, or other optimization algorithms to determine the scaling factor that results in the minimum value of the loss function.

Next, the processor 130 uses the product of the scaling factor and a new positioning coordinate as the corrected new positioning coordinate. For example, the corrected new positioning coordinates P″=S·P′=[Sₓ·x_{P′1} S_{y}·y_{P′1} S_{z}·z_{P′1}], [Sₓ·x_{P′2} S_{y}·y_{P′2} S_{z}·z_{P′2}], . . . , [Sₓ·x_{P′n} S_{y}·y_{P′n} S_{z}·z_{P′n}]. At this point, the corrected moving route information corresponds to the route between the estimated position information and the corrected new positioning-point position information (including one or more corrected new positioning points and their corrected new positioning coordinates).

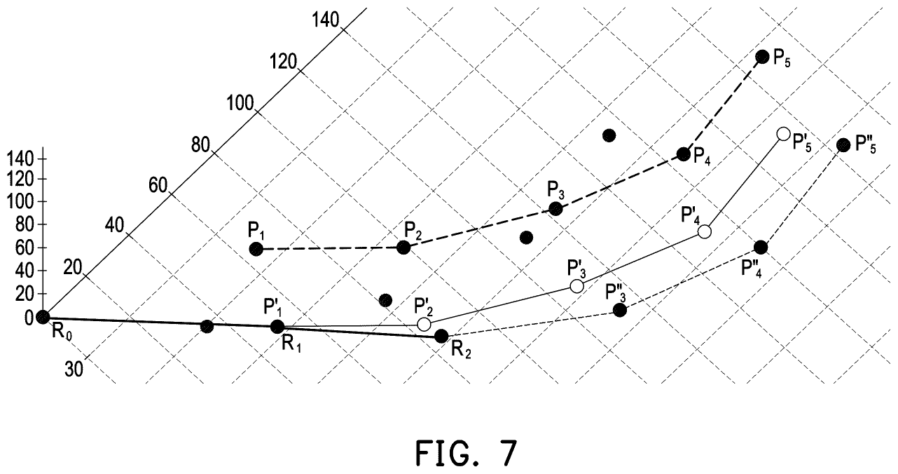

For example, FIG. 7 is a schematic diagram of moving route information according to an embodiment of the disclosure. Referring to FIG. 7, a corrected reference route information P″ is the set of corrected new positioning points P″₃, P″₄, and P″₅=[164.444 100.36 120.4], [182.22 145.36 118.25], [169.33 196.55 93.73].

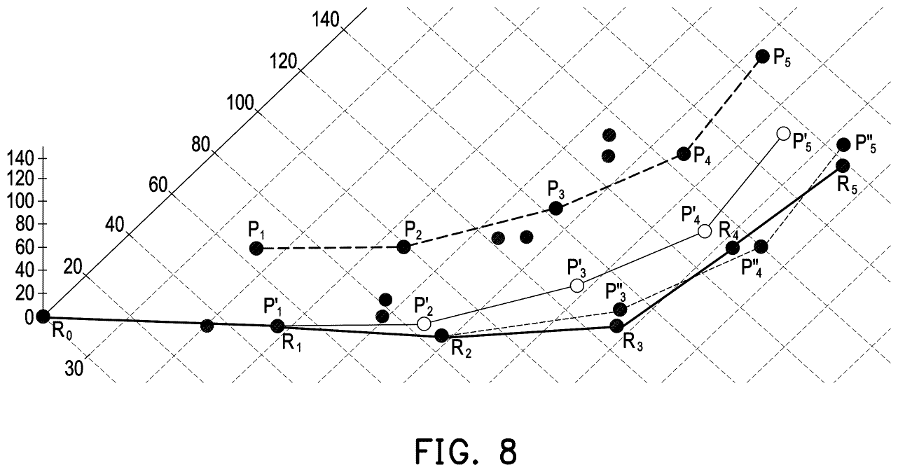

FIG. 8 is a schematic diagram of moving route information according to an embodiment of the disclosure. Referring to FIG. 8, the autonomous mobile device 100 moves based on the corrected reference route information formed by the corrected new positioning coordinates (i.e., the corrected new positioning points P″₃, P″₄, and P″₅) and is positioned at the actual points R₃, R₄, and R₅, respectively. Compared to the new positioning points P′₃, P′₄, and P′₅, the actual points R₃, R₄, and R₅ are closer to the corrected new positioning points P″₃, P″₄, and P″₅.

In an embodiment, the processor 130 may control the motion mechanism 110 to move along the corrected moving route information. For example, the processor 130 may generate control instructions based on the determined moving route information, enabling the motion mechanism 110 to move forward, backward, rotate/turn, accelerate, decelerate, and/or stop according to the control instructions.

In summary, in the route correction method and the autonomous mobile device in the embodiments of the disclosure, positioning and route correction are performed based on the deviation information between the reference position information determined from the captured image and the estimated position information based on motion information. Accordingly, accurate and reliable positioning may be provided in environments where satellite positioning is unavailable or difficult to achieve, avoiding the problem of exacerbating route deviation due to continued travel, and thereby improving the efficiency of mission execution.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A route correction method, applicable to an autonomous mobile device, the route correction method comprising:
determining a reference position information corresponding to a reference point in a captured image, wherein the captured image is taken from the reference point in an environment;
determining a deviation information between an estimated position information and the reference position information, wherein the estimated position information is estimated based on a motion information of the autonomous mobile device; and
correcting a moving route information of the autonomous mobile device according to the deviation information, wherein the moving route information corresponds to a route between the estimated position information and a positioning-point position information.

2. The route correction method according to claim 1, wherein the estimated position information comprises a first estimated coordinate at a current time point, the reference position information comprises a first reference coordinate at the current time point, the deviation information comprises a deviation value between the first estimated coordinate and the first reference coordinate, and correcting the moving route information of the autonomous mobile device based on the deviation information comprises:
correcting a positioning point corresponding to the positioning-point position information into a new positioning point based on the deviation value, wherein the new positioning point and the positioning point have the deviation value therebetween.

3. The route correction method according to claim 1, wherein the corrected moving route information comprises a plurality of new positioning coordinates of a plurality of new positioning points, the reference position information comprises a plurality of reference coordinates of a plurality of reference points respectively corresponding to the plurality of new positioning points, and correcting the moving route information of the autonomous mobile device according to the deviation information comprises:
determining a loss function according to a distance between two of the plurality of new positioning points and a distance between two of the plurality of reference points, wherein the distance between the two of the plurality of new positioning points is a difference between corresponding two of the plurality of new positioning coordinates, the distance between the two of the plurality of reference points is a difference between corresponding two of the plurality of reference coordinates, and the difference between the two of the plurality of new positioning coordinates in the loss function corresponds to a scaling factor; and
minimizing the loss function and determining the scaling factor, wherein the scaling factor is used to correct the two of the plurality of new positioning coordinates.

4. The route correction method according to claim 3, wherein the loss function is a difference between a first value and a second value, the first value is the distance between the two of the plurality of new positioning points, and the second value is a product of the distance between the two of the plurality of reference points and the scaling factor.

5. The route correction method according to claim 3, wherein minimizing the loss function comprises:
determining a minimum value of the loss function through a gradient descent method, wherein the minimum value corresponds to the scaling factor.

6. The route correction method according to claim 3, further comprising:
using a product of the scaling factor and one of the plurality of new positioning coordinates as a corrected new positioning coordinate.

7. The route correction method according to claim 1, further comprising:
determining the estimated position information corresponding to the motion information of the autonomous mobile device according to an initial position information, wherein the initial position information is known.

8. The route correction method according to claim 1, further comprising:
determining whether the deviation information meets a correction condition, wherein the correction condition is that a deviation value corresponding to the deviation information is greater than a deviation threshold value;
in response to the deviation information meeting the correction condition, correcting the moving route information of the autonomous mobile device; and
in response to the deviation information meeting the correction condition, prohibiting correcting the moving route information of the autonomous mobile device.

9. The route correction method according to claim 1, wherein determining the reference position information corresponding to the reference point in the captured image comprises:
converting the captured image into a vector encoding, wherein the vector encoding is one-dimensional; and
determining the reference position information corresponding to the vector encoding.

10. The route correction method according to claim 1, further comprising:
controlling the autonomous mobile device to move along the corrected moving route information, wherein the positioning-point position information corresponds to at least one positioning point in a total route of the autonomous mobile device, and the total route is a set of routes passing through the at least one positioning point.

11. An autonomous mobile device, comprising:
a storage, storing a code; and
a processor, coupled to the storage, wherein the processor loads the code and executes:
determining a reference position information corresponding to a reference point in a captured image, wherein the captured image is taken from the reference point in an environment;
determining a deviation information between an estimated position information and the reference position information, wherein the estimated position information is estimated based on a motion information of the autonomous mobile device; and
correcting a moving route information of the autonomous mobile device according to the deviation information, wherein the moving route information corresponds to a route between the estimated position information and a positioning-point position information.

12. The autonomous mobile device according to claim 11, wherein the estimated position information comprises a first estimated coordinate at a current time point, the reference position information comprises a first reference coordinate at the current time point, the deviation information comprises a deviation value between the first estimated coordinate and the first reference coordinate, and the processor further executes:
correcting a positioning point corresponding to the positioning-point position information into a new positioning point based on the deviation value, wherein the new positioning point and the positioning point have the deviation value therebetween.

13. The autonomous mobile device according to claim 11, wherein the corrected moving route information comprises a plurality of new positioning coordinates of a plurality of new positioning points, the reference position information comprises a plurality of reference coordinates of a plurality of reference points respectively corresponding to the plurality of new positioning points, and the processor further executes:
determining a loss function according to a distance between two of the plurality of new positioning points and a distance between two of the plurality of reference points, wherein the distance between the two of the plurality of new positioning points is a difference between corresponding two of the plurality of new positioning coordinates, the distance between the two of the plurality of reference points is a difference between corresponding two of the plurality of reference coordinates, and the difference between the two of the plurality of new positioning coordinates in the loss function corresponds to a scaling factor; and
minimizing the loss function and determining the scaling factor, wherein the scaling factor is used to correct the two of the plurality of new positioning coordinates.

14. The autonomous mobile device according to claim 13, wherein the loss function is a difference between a first value and a second value, the first value is the distance between the two of the plurality of new positioning points, and the second value is a product of the distance between the two of the plurality of reference points and the scaling factor.

15. The autonomous mobile device according to claim 13, wherein the processor further executes:
determining a minimum value of the loss function through a gradient descent method, wherein the minimum value corresponds to the scaling factor.

16. The autonomous mobile device according to claim 13, wherein the processor further executes:
using a product of the scaling factor and one of the plurality of new positioning coordinates as a corrected new positioning coordinate.

17. The autonomous mobile device according to claim 11, wherein the processor further executes:
determining the estimated position information corresponding to the motion information of the autonomous mobile device according to an initial position information, wherein the initial position information is known.

18. The autonomous mobile device according to claim 11, wherein the processor further executes:
determining whether the deviation information meets a correction condition, wherein the correction condition is that a deviation value corresponding to the deviation information is greater than a deviation threshold value;
in response to the deviation information meeting the correction condition, correcting the moving route information of the autonomous mobile device; and
in response to the deviation information meeting the correction condition, prohibiting correcting the moving route information of the autonomous mobile device.

19. The autonomous mobile device according to claim 11, wherein the processor further executes:
converting the captured image into a vector encoding, wherein the vector encoding is one-dimensional; and
determining the reference position information corresponding to the vector encoding.

20. The autonomous mobile device according to claim 11, further comprising:
a motion mechanism, coupled to the processor, wherein the processor further executes:
controlling the motion mechanism to move along the corrected moving route information, wherein the positioning-point position information corresponds to at least one positioning point in a total route of the autonomous mobile device, and the total route is a set of routes passing through the at least one positioning point.
